(19) United States
(12) Patent Application Publication
(10) Pub. No.: US 2008/0012764 A1
(43) Pub. Date: Jan. 17, 2008

(54) Apparatus, method and computer program product providing protected feedback signaling transmission in uplink closed-loop MIMO

(75) Inventors: Jianfeng Kang, Beijing (CN); Olav Tirkkonen, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/824,162

(22) Filed: Jun. 28, 2007

Related U.S. Application Data
(60) Provisional application No. 60/817,256, filed on Jun. 28, 2006.

(51) Int. Cl. H04B 1/00

(52) U.S. Cl. 342/367

(57) ABSTRACT

A device configured to perform communication operations, the device having a transceiver and a control unit. The transceiver is configured to receive a signal incorporating scheduling grant and antenna weight feedback information from a remote receiver in a wireless communications system. The control unit is configured to verify correct receipt of the signal incorporating the scheduling grant and antenna weight feedback information and to use the antenna weight feedback information to control beamforming operations performed by the device when performing signal transmission operations. A computer program product composed of a computer readable memory medium storing a computer program. The computer program, when executed, is configured to cause a device to receive a signal incorporating scheduling grant and antenna weight feedback information from a remote receiver in a wireless communication system; and to verify correct receipt of the signal and to use the antenna weight feedback information to control beamforming operations performed by the device when performing signal transmission operations.

### CROSS REFERENCE TO A RELATED UNITED STATES PATENT APPLICATION

This application hereby claims priority under 35 U.S.C. §119(e) from copending provisional U.S. Patent Application No. 60/817,256 entitled “APPARATUS, METHOD AND COMPUTER PROGRAM PRODUCT PROVIDING PROTECTED FEEDBACK SIGNALING TRANSMISSION IN UPLINK CLOSED-LOOP MIMO” filed on Jun. 28, 2006 by Jianfeng Kang and Olav Tirkkonen. This preceding provisional application is hereby incorporated by reference in its entirety as if fully restated herein.

### TECHNICAL FIELD

The exemplary and non-limiting embodiments of this invention relate generally to wireless communications systems, methods, devices and computer program products and, more specifically, relate to closed loop multi-input, multi-output transmission techniques.

### BACKGROUND

The following abbreviations are defined as follows:
LTE Long Term Evolution
UTRAN Universal Terrestrial Radio Access Network
E-UTRAN Evolved UTRAN
MIMO multi-input and multi-output
MISO multi-input, single output
CSI channel state information
BF beamforming
BS base station, also referred to as a Node-B in E-UTRAN
UE user equipment
DL downlink
UL uplink
CRC cyclic redundancy check
RU resource unit
CL closed-loop
Tx transmitter
Rx receiver
SNR signal to noise ratio
WCDMA wideband code divisional multiple access
FDMA frequency division multiple access
CPICH common pilot channel
FBI feedback information
HARQ hybrid automatic repeat request
MCS modulation and coding scheme
BPSK binary phase shift keying
TxAA Transmit Adaptive Array

In a closed-loop MIMO system feedback information in the form of antenna weight factors is sent back to a transmitter from a remote receiver. The transmitter then applies the antenna weight factors during signal transmission. That is, by adjusting the weights associated with transmitted signals beamforming is accomplished. Due to the need for CSI at the Tx end it may be appreciated that there is a greater need for knowledge of the wireless channel in the closed-loop MIMO case as compared to, for example, open-loop MIMO, otherwise the desired SNR gain could be obtained at the Rx end.

As may be appreciated, a problem that arises is how to make the transmitter correctly receive the important feedback information that must pass through the vulnerable wireless channel from the receiver.

In current 3GPP standards for WCDMA, mode 1 of TxAA is designed for closed-loop downlink MISO. Reference in this regard may be had to 3GPP TS25.211, 3rd Generation Partnership Project; Technical Specification Group Radio Access Network; Physical channels and mapping of transport channels onto physical channels (FDD) (Release 7)(hereby incorporated by reference in its entirety as if fully restated herein), and to 3GPP TS25.214, 3rd Generation Partnership Project; Technical Specification Group Radio Access Network; Physical layer procedures (FDD) (Release 7)(hereby incorporated by reference in its entirety as if fully restated herein). In this scheme, the UE uses the CPICH transmitted from a first antenna and a second antenna to calculate a phase adjustment. The weight factor (w) for the second antenna is multiplexed into an FBI field and transmitted back to the BS. The BS then performs phase rotation according to the received FBI signaling.

Generally, TxAA is a MIMO technique that implies the use of multiple transmit antennas and single/multiple receive antennas, e.g., 2×1 or 2×2.

However this signaling is transmitted without protection, and the feedback error may be assumed to be in the range of about 4%-20%. One can assume that one of the key factors degrading closed-loop MIMO performance is the signaling error. Reference in this regard may be had to Ari Hottinen, Olav Tirkkonen, Risto Wichman, “Multi-antenna transceiver techniques for 3G and beyond”, Wiley, 2003, pgs. 215, 216, (hereby incorporated by reference in its entirety as if fully restated herein).

The inventors have realized that existing procedures used for feedback and for verification are not adequate for use in an advanced MIMO system.

### SUMMARY OF THE INVENTION

An embodiment of the invention is a device comprising: a receiver configured to receive a signal from a remote transmitter operating in a wireless communication system, the signal comprising at least antenna weight feedback information and a signal protection component; a transmitter configured to perform signal transmission operations; an antenna array coupled to the transmitter; and a control unit configured to verify correct receipt of the signal using the signal protection component; to cause the transmitter to perform signal transmission operations; and, when the signal is verified as correctly received, to use the antenna weight feedback information to control beamforming operations when performing signal transmission operations using the antenna array.

Another embodiment of the invention is a device comprising: a receiver configured to receive a first signal transmitted by a remote device operating in a wireless communication system; a transmitter configured to transmit a second signal to the remote device operating in the wireless communication system; and a control unit configured to use the first signal to select antenna weight feedback information; to generate the second signal, the second signal comprising at least the antenna weight feedback information, the antenna weight feedback information for use by the remote device when performing signal transmission operations; to add a signal protection component to the second signal; and to cause the transmitter to transmit the second signal with the signal protection component.

A further embodiment of the invention is a computer program product comprising a computer readable memory medium tangibly embodying a computer program, the computer program configured to be executed by processing apparatus associated with a wireless device operative in a wireless communications system, wherein when executed by the processing apparatus, the computer program is configured to cause the wireless device to receive a signal, the signal comprising antenna weight feedback information and a signal protection component; to verify correct receipt of the antenna weight feedback information using the signal protection component; and, when the antenna weight feedback information is verified as correctly received, to use the antenna weight feedback information to control beamforming operations when the wireless device is performing signal transmission operations.

A still further embodiment of the invention is a computer program product comprising a computer readable memory medium tangibly embodying a computer program, the computer program configured to be executed by processing apparatus associated with a wireless device operative in a wireless communications system, wherein when executed by the processing apparatus, the computer program is configured to cause the wireless device to receive a first signal transmitted by a remote device operating in the wireless communications system; to use the first signal to select antenna weight feedback information for use by the remote device when the remote device performs signal transmission operations; to generate a second signal, the second signal comprising the antenna weight feedback information and a signal protection component; and to transmit the second signal to the remote device.

Another embodiment of the invention is a method comprising: receiving a signal comprising antenna weight feedback information and a signal protection component from a remote first wireless device operating in a wireless communications system; verifying correct receipt of the antenna weight feedback information using the signal protection component; and only if the antenna weight information is verified as correctly received, using the antenna weight feedback information to control beamforming when a second wireless device is using an antenna array to perform signal transmission operations in the wireless communications system.

A further embodiment of the invention is a method comprising: receiving a first signal transmitted by a remote device operative in a wireless communications system; using the first signal to select antenna weight feedback information; generating a second signal, the second signal comprising at least the antenna weight feedback information, the antenna weight feedback information for use by the remote device when performing signal transmission operations with an antenna array; adding a signal protection component to the second signal; and transmitting the second signal to the remote wireless device.

A still further embodiment of the invention is a device comprising: receiver means for receiving a signal from a remote transmitter operating in a wireless communication system, the signal comprising at least antenna weight feedback information and a signal protection component; transmitter means for performing signal transmission operations; an antenna array coupled to the transmitter means; and control means for verifying correct receipt of the signal using the signal protection component; for causing the transmitter means to perform signal transmission operations; and, when the signal is verified as correctly received, for using the antenna weight feedback information to control beamforming operations when performing signal transmission operations using the antenna array.

Another embodiment of the invention is a device comprising: receiver means for receiving a first signal transmitted by a remote device operating in a wireless communications system; transmitter means for transmitting a second signal to the remote device operating in the wireless communications system; and control means for using the first signal to select antenna weight feedback information; for generating the second signal, the second signal comprising at least the antenna weight feedback information, the antenna weight feedback information for use by the remote device when performing signal transmission operations; for adding a signal protection component to the second signal; and for causing the transmitter means to transmit the second signal with the signal protection component.

In conclusion, the foregoing summary of the various embodiments of the present invention is exemplary and non-limiting. For example, one of ordinary skill in the art will understand that one or more aspects or steps from one embodiment can be combined with one or more aspects or steps from another embodiment to create a new embodiment within the scope of the present invention.

### BRIEF DESCRIPTION OF THE DRAWINGS

In the attached Drawing Figures:

FIG. 1 shows a simplified block diagram of various electronic devices that are suitable for use in practicing the exemplary embodiments of this invention.

FIG. 2 shows a control channel structure related to UL signaling.

FIGS. 3A and 3B illustrate exemplary embodiments of variable length and fixed length, respectively, UE allocation table entries that may contain TxAA-related feedback information in accordance with the exemplary embodiments of this invention.

FIG. 4 is a logic flow diagram that is illustrative of a method in accordance with the exemplary embodiments of this invention.

### DETAILED DESCRIPTION

The exemplary embodiments of this invention relate to closed-loop MIMO (CL-MIMO) for uplink LTE (UTRAN LTE or E-UTRAN), although it should be appreciated that the exemplary embodiments of this invention can also be applied to other types of radio frequency communication systems and system architectures.

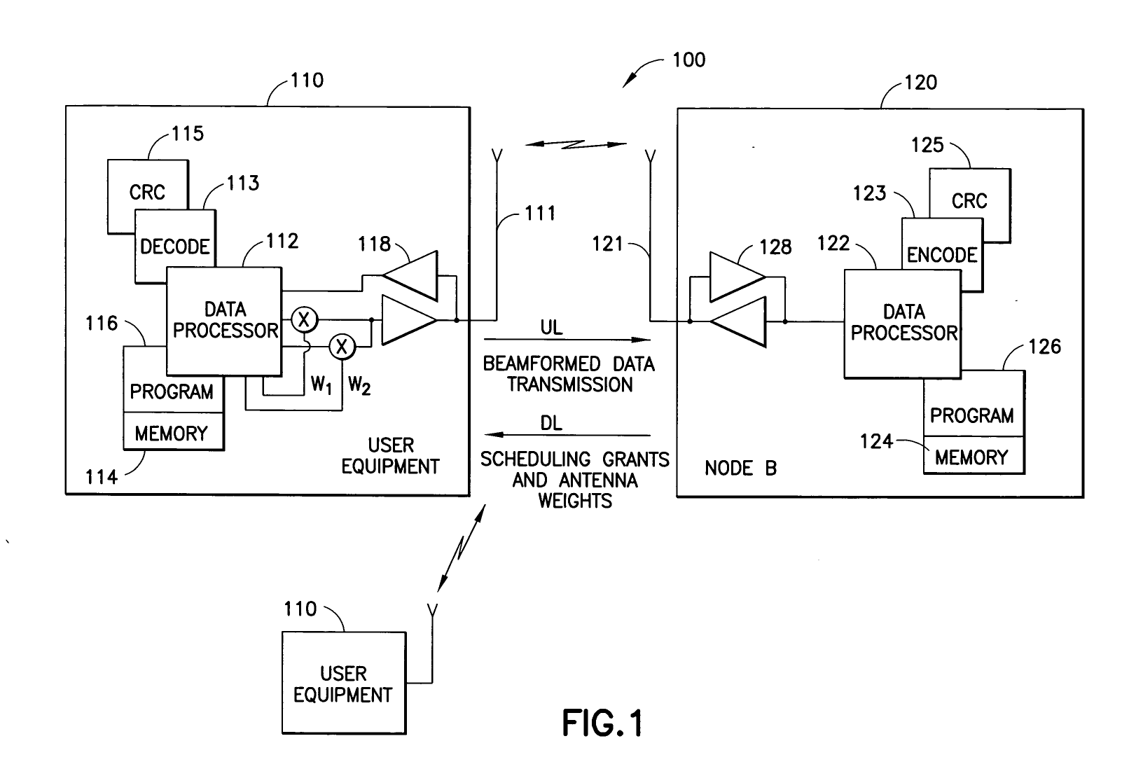

Reference is made first to FIG. 1 for illustrating a simplified block diagram of various electronic devices that are suitable for use in practicing the exemplary embodiments of this invention. In FIG. 1 a wireless network 100 is adapted for communication with a UE 110 via a Node B (base station) 120. There will typically be a plurality of UEs present, possibly having different operational characteristics. The UE 110 includes a data processor (DP) 112, a memory (MEM) 114 that stores a program (PROG) 116, and a suitable radio frequency (RF) transceiver 118 for bidirectional wireless communications with Node B 120, which also includes a DP 122, a MEM 124 that stores a PROG 126, and a suitable RF transceiver 128. Antenna 111 in UE 110 actually comprises an antenna array; other UE 110, nonetheless, may have only a single antenna. The same applies to Node-B 120.

FIG. 1 also shows the application of weights (e.g., W1, W2) to the signal transmitted from the UE 110, and a channel decoder 113 and CRC unit 115, and a corresponding channel encoder 123 and CRC unit 125 at Node-B 120. These components are used as discussed below.

As will be explained more fully below, the PROGs 116 and 126 are assumed to include program instructions that, when executed by the associated DP, enable the electronic device to operate in accordance with the exemplary embodiments of this invention. Note further that while the exemplary embodiments of this invention may be implemented by computer software executable by DP 1 12 of the UE 110 and the DP 122 of the Node-B 120, they may also be implemented at least in part by hardware, or by a combination of software and hardware (and firmware).

In general, the various embodiments of the UE 110 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 114 and 124 may be of any type suitable to the local technical environment and may be implemented using any suitable data storage technology, such as semiconductor-based memory devices, magnetic memory devices and systems, optical memory devices and systems, fixed memory and removable memory. The DPs 112 and 122 may be of any type suitable to the local technical environment, and may include one or more of general purpose computers, special purpose computers, microprocessors, digital signal processors (DSPs) and processors based on a multi-core processor architecture, as non-limiting examples.

For the UL LTE system of particular interest to the exemplary embodiments of this invention UL scheduling grants are proposed to be transmitted to the UEs 110 on a DL control channel. In addition, the consensus understanding is currently that transport format selection, or at least the majority of the transport format selection, will be performed by the Node B 120. This means that the UL scheduling grants will most likely include a transport format indication field as well.

In accordance with the exemplary embodiments of this invention, for UL CL-MIMO the problems related to feedback errors, complex verification algorithms and verification errors are overcome, as now described.

Briefly, for the feedback signaling transmission, (a) the TxAA feedback signaling is multiplexed into the DL control channel, and protected by a CRC or by channel coding, as two non-limiting examples; and (b) only if both the UL scheduling grant and the feedback signaling for TxAA are determined as being received correctly through a CRC check or by channel decoding (as examples), the transmitter (the UE 110 transmitter in this case) uses the corresponding beam for UL data transmission. In this case the receiver (the Node-B receiver in this case) can trust that the indicated beam is being used by the transmitter, since the signaling on the DL was protected. Thus, no verification procedure by the receiver is needed.

The exemplary embodiments of this invention may be practiced by the introduction of a bit field in the UL scheduling grants transmitted on the DL control channel. This bit field indicates with a low number of bits the preferred weight(s) for TxAA, or double TxAA (D-TxAA), or triple TxAA, etc., or more generically for a pre-coding matrix. The UL scheduling grants are CRC protected, and may be protected by channel coding as well. This procedure thus automatically guarantees that the allocation information and the weight information are protected, and the UE 110 has knowledge that both are correctly received as a result of the use of CRC 115 and/or the channel decoder 113. The coding and CRC protection may be UE-specific, or it may be joint for all UEs that receive an UL scheduling grant in a given sub-frame.

In the LTE UL the selected transmission method is single-carrier FDMA. The current consensus appears to be converging towards alternatives being a distributed FDMA (IFDMA) and a localized FDMA. In the latter, the UE 110 is allocated a number of consecutive Resource Units, each tentatively corresponding to a 375 kHz bandwidth. For a single carrier transmission, only one weight set may be used. Thus, for localized and distributed FDMA, only one set of weights need to be signaled.

In addition, a distributed transmission method may be employed, where the UE 1 10 may be allocated multiple Resource Units that may not necessarily be in neighboring parts of the radio spectrum. For such a case, the feedback weights may be selected and signaled for each set of continuous Resource Units allocated to the user. Thus, in the DL the scheduling grant may include the following information:
a) the UL allocation (the RUs);
b) the LJE identification (e.g. C-RLTI);
c) the transport format, including the modulation format, channel code and rate, rate matching algorithm information, MIMO streams and precoding (TxAA weights);
d) HARQ information (if HARQ is adaptive/asynchronous); and
e) the duration of the allocation (if allocations for multiple sub-frames are supported).

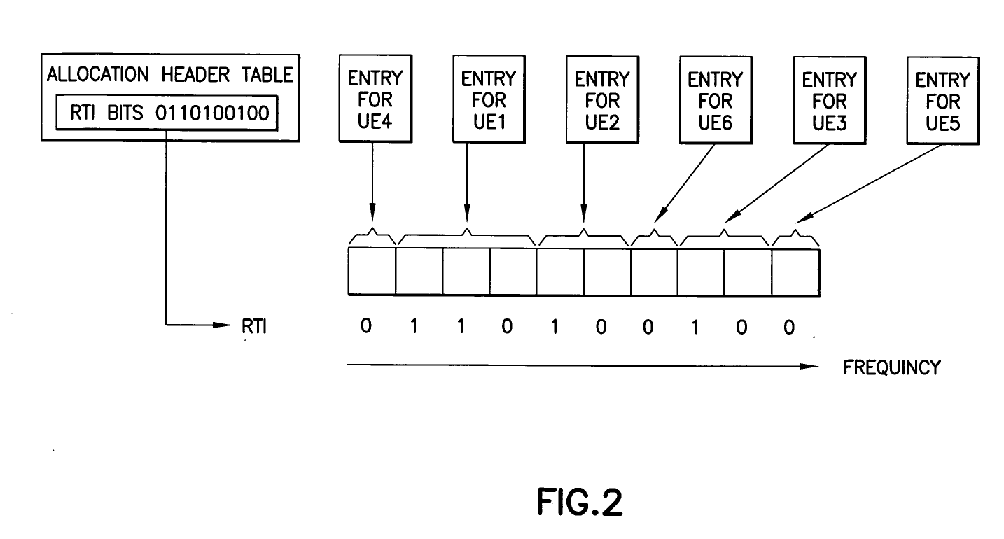

In contribution R1-060803 (3GPP TSG-RAN WG1 Meeting 44#bis, Athens, Greece, 27-31 Mar. 2006, Agenda item: 10.1.1, Source: Nokia, Title: Downlink signaling for UTRA LTE, (hereby incorporated by reference in its entirety as if fully restated herein), a discussion is made of DL control signaling for UL scheduling grants. FIG. 2 shows the proposed structure. The allocation information is jointly encoded so that it is a combination of the allocation table (AT) header and the implicit information in the order of the entries in the AT. The header and the entries may or may not be separately channel and CRC encoded. Alternatively, one may have a structure where the allocation information is signaled within each UE entry, and these entries may or may not be separately channel and CRC encoded.

It is desirable that the various UEs 110 have knowledge of how to separate the different UE entries, as it is likely that some UEs are UL-MIMO capable while others are not, and furthermore that some UEs, although UL-MIMO capable, would not utilize TxAA. As such, it can be expected that pre-coding matrix weight information would need to be signaled to some UEs but not to others.

In accordance with exemplary embodiments of this invention the signaling may be implemented in accordance with the following techniques.

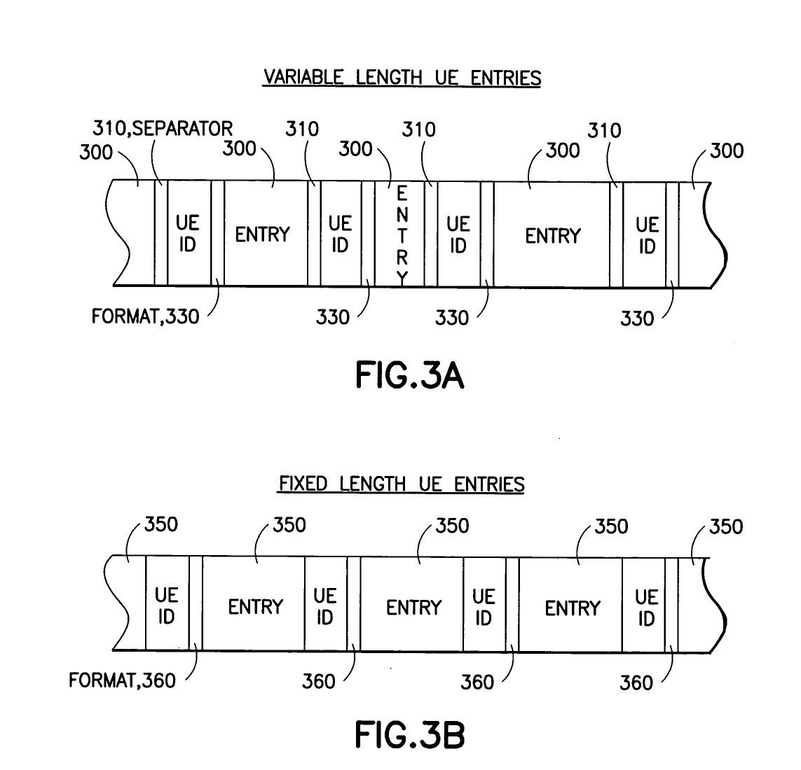

Referring to FIG. 3A, in a first exemplary embodiment UE entries 300 may be of variable length. In this case a separator field 310 is defined which is sufficiently long so that, considering the possible placements of the separator field 310 in the allocation table, it cannot be confused with possible signaling entries, taking into account the different lengths. In this case the UEs 110 would need to know the format of the UE entries targeted to them. This information can be imparted to the UEs 110 through the use of higher layer signaling. Alternatively, the format (and implicitly length) of a given UE entry 300 may be signaled by a bit field 330 at the beginning of the UE entry 300. A bit in a UE entry (or the first bit following the UE ID) may indicate whether the entry contains TxAA weight information or does not contains TxAA weight information.

Referring to FIG. 31B, in a second exemplary embodiment the UE entries 350 may be of fixed length. In this case it can be appreciated that the transport format, HARQ and length of the allocation information signaling would be different for those UEs that employ TxAA than for those UEs that do not employ TxAA. Thus, a TxAA-capable UE 110 may have, for example, a limited set of durations of allocations, or a limited MCS set. For example, TxAA UEs may have a MCS set without BPSK, whereas non-TxAA UEs may have a MCS set with BPSK. This is logically consistent, as the TxAA would improve the coverage for higher order modulations, and BPSK likely would not to be needed for TxAA-capable UEs, and thus BPSK related information would need not be signaled. Related to signaling the UE 110 AT entry format, there are at least two alternative embodiments: (a) the use of higher layer signaling to inform the UE of AT entry format that is in use, and (b) a bit field 360 in the UE AT entry that specifies the entry format. For example, the first bit in a UE entry (or the first bit following the UE ID) may indicate whether the entry does or does not contain TxAA weight information.

As can be appreciated, through the use of the exemplary embodiments of this invention reliable signaling transmission can be assured, thereby enhancing the beamforming gain. In addition, a verification procedure (to ensure that the signaled information was accurately received by the Tx) is not required.

Based on the foregoing it should be apparent that the exemplary embodiments of this invention provide a method, apparatus and computer program product(s) to provide CL-MIMO feedback information from a receiver to a transmitter.

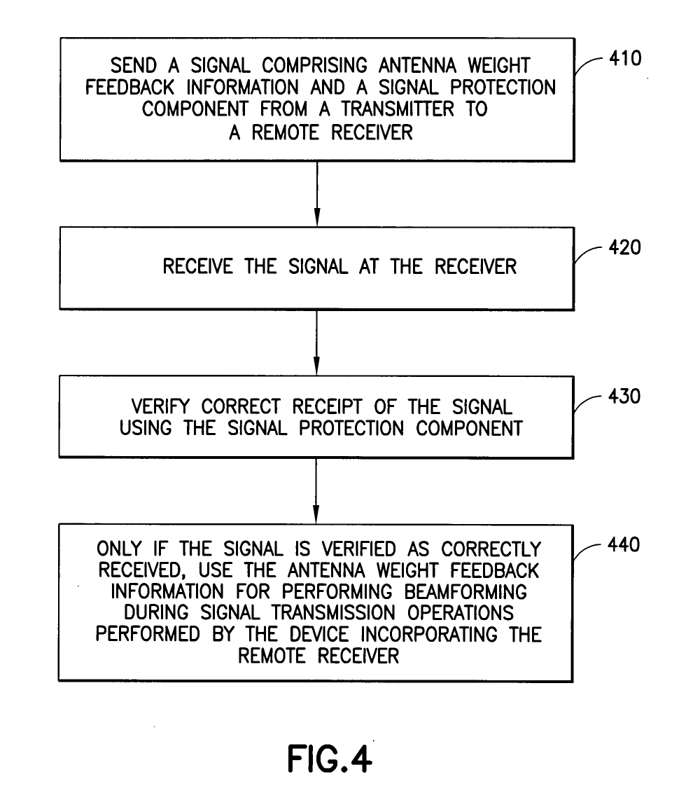

Referring to FIG. 4, in accordance with an exemplary method of the invention the following operations are performed. At 410, a signal comprising antenna weight feedback information and a signal protection component is sent from a transmitter to a receiver. Next, at 420, the receiver receives the signal. Then, at 430, the wireless device incorporating the receiver verifies correct receipt of the signal using the signal protection component, Next, at 440, if the signal channel is verified as correctly received, using the antenna weight feedback information for use in beamforming a transmission from the wireless device to the transmitter. The antenna weight information may be signaled as part of an allocation table entry for a specific transmitter, and the entry may be one of variable length or fixed length. The signal protection component may comprise a CRC or channel coding, or a combination of CRC and channel coding, as non-limiting examples of signal protection components. The wireless device may be a TxAA-capable UE, and the transmitter may be a Node-B of an E-UTRAN or similar wireless communications system.

Another exemplary embodiment of this invention is a device comprising a receiver; a transmitter; an antenna array; and a control unit. In one exemplary and non-limiting embodiment, the device is implemented in the manner of UE 110 depicted in FIG. 1. The control unit comprises at least the data processor 112; the memory 114 and one or both of the decode 113 and CRC 115 units. Together, the transmitter and receiver may comprise the transceiver 118 as depicted in FIG. 1, or they may be implemented as separate units. The receiver is configured to receive a signal from a remote transmitter (such as, for example, a transmitter associated with base station 120 depicted in FIG. 1). The signal comprises at least antenna weight feedback information and a signal protection component. The control unit is configured to verify correct receipt of the signal using the signal protection component; to cause the transmitter to perform signal transmission operations; and to use the antenna weight feedback information to control beamforming operations when performing signal transmission operations using the antenna array.

The antenna weight information may be signaled as part of an allocation table intended specifically for UE 110, and the entry may be of variable length or fixed length. The signal protection component may comprise a CRC, or a channel code, or a combination of a CRC and a channel code, as non-limiting examples of signal protection components. In more general terms, the signal protection component may comprise an error detection component; or an error correction component; or the combination of error detection and error correction components. When the signal protection component comprises a CRC code, the control unit is configured to use the CRC code to verify correct receipt of the signal. When the signal protection component comprises a channel code, the control unit is configured to use the channel code to at least verify correct receipt of the signal. In a further variant, the control unit may use the channel code to correct signal transmission errors. The wireless device may be a TxAA-capable UE, and the remote base station may be a Node-B of an E-UTRAN or similar wireless communications system.

A further exemplary embodiment of the invention is a computer program product comprising a computer program 116 tangibly embodied in, for example, a memory 114 of user equipment 110 as depicted in FIG. 1. The computer program 116, when executed by data processor 112 or other processing apparatus, is configured to cause the user equipment to perform operations. In one operation, a receiver of the user equipment is operated to receive a signal transmitted by a remote wireless device operating in a wireless communications system. The signal comprises at least antenna weight feedback information and a signal protection component. In another operation, the user equipment verifies correct receipt of the antenna weight feedback information using the signal protection component. In one variant, the signal protection component comprises a CRC code, and the program, when executed, controls the CRC unit 115 to perform error detection on the signal. In another variant, the signal protection component comprises a channel code, and the program, when executed, controls the Decode unit 113 to perform channel decoding of the signal. This may comprise error correction in addition to error detection. In a further operation, the program, when executed, causes UE 110 to use the antenna weight feedback information to control beamforming operations involving antenna array 111 during signal transmission operations.

The signal may further comprise an allocation table intended for the UE 110, wherein the antenna weight feedback information comprises an entry in the allocation table. The UE may be TxAA-capable.

Yet another exemplary embodiment of the invention is a device comprising a receiver; a transmitter; and a control unit. In one exemplary and non-limiting embodiment, the device may be implemented in the manner of Node B 120 as depicted in FIG. 1. The control unit comprises at least data processor 122; memory 124; and one or both of the Encode 123 and CRC 125 units. Together, the transmitter and receiver may comprise the transceiver 128 as depicted in FIG. 1, or they may be implemented as separate units. The receiver is configured to receive a first signal transmitted by a remote device (such as, for example UE 110) operating in a wireless communications system. The control unit is configured to use the first signal to select antenna weight feedback information; to generate a second signal, the second signal comprising at least the antenna weight feedback information; to add a signal protection component to the second signal; and to cause the transmitter to transmit the second signal with the signal protection component. The signal protection component may be a CRC, or a channel code, or a combination of a CRC and a channel code, as non-limiting examples of signal protection components. In more general terms, the signal protection component may comprise one or both of an error detection component and an error correction component. When the signal protection component is a CRC, the control unit is configured to operate the CRC unit 125 to add a CRC code component to the second signal. When the signal protection component is a channel code, the control unit is configured to operate the Encoding unit 123 to add a channel code component to the second signal. When the signal protection component is a combination of a CRC and channel code, the control unit is configured to operate the Encode 123 and CRC 125 units to add CRC and channel code components to the second signal.

The second signal may further comprise an allocation table intended for a specific wireless device (such as UE 110) operating in the wireless communication system, the antenna weight feedback information comprising an entry in the allocation table. The entry may be of variable or fixed length. The device may be a Node-B of an E-UTRAN or similar wireless communications system.

A still further exemplary embodiment of the invention is a computer program product comprising a computer program 126 tangibly embodied in, for example, a memory 124 of Node B 120 as depicted in FIG. 1. The computer program 126, when executed by data processor 122 or other processing apparatus, is configured to cause Node B 120 to perform operations. In one operation, a receiver (or receiver component of a transceiver) is operated to receive a signal transmitted by a remote device (such as, for example, UE 110) operating in wireless communications system 100. In further operations, the computer program, when executed, is configured to cause Node B 120 to use the first signal to select antenna weight feedback information; to generate a second signal, the second signal comprising at least the antenna weight feedback information, the antenna weight feedback information for use by the remote device when performing signal transmission operations; to add a signal protection component to the second signal; and to cause a transmitter to transmit the second signal with the signal protection component. In one variant, the signal protection component comprises a CRC code, and the program, when executed, controls the CRC unit 125 to add a CRC code to the second signal. In another variant, the signal protection component comprises a channel code, and the program, when executed, controls the Encode Unit 123 to add a channel code to the second signal.

The device may be a Node-B of an E-UTRAN or similar wireless communications system.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the invention may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

One of ordinary skill in the art understands that methods depicted and described herein can be embodied in a computer program tangibly stored in a computer readable memory medium. Instructions embodied in the tangible computer-readable memory medium perform the steps of the methods when executed by processing apparatus of a wireless device operating in a wireless communications system. Tangible computer-readable memory media include, but are not limited to, hard drives, CD- or DVD ROM, flash memory storage devices or in a RAM memory of a computer system.

Thus it is seen that the foregoing description has provided by way of exemplary and non-limiting examples a full and informative description of the best methods and apparatus presently contemplated by the inventors for performing protected feedback signaling transmission in uplink closed-looped MIMO. One skilled in the art will appreciate that various embodiments described herein can be practiced individually; in combination with one or more other embodiments described herein; or in combination with wireless devices and wireless communication systems differing from those described herein. Further, one skilled in the art will appreciate that the present invention can be practiced by other than the described embodiments; that these embodiments are presented for the purposes of illustration and not of limitation; and that the present invention is therefore limited only by the claims which follow.

What is claimed is:

1. A device comprising:
a receiver configured to receive a signal from a remote transmitter operating in a wireless communications system, the signal comprising at least antenna weight feedback information and a signal protection component;
a transmitter configured to perform signal transmission operations;
an antenna array coupled to the transmitter; and
a control unit configured to verify correct receipt of the signal using the signal protection component; to cause the transmitter to perform signal transmission operations; and when the signal is verified as received correctly, to use the antenna weight feedback information to control beamforming operations when performing signal transmission operations using the antenna array.

2. The device of claim 1 wherein the signal protection component comprises a cyclic redundancy check (CRC) code and where the control unit is further configured to use the CRC code to verify correct receipt of the signal.

3. The device of claim 1 wherein the signal protection component comprises a channel code and where the control unit is further configured to use the channel code to verify correct receipt of the signal.

4. The device of claim 1 where the signal further comprises uplink scheduling grant information, and where the control unit is further configured to verify correct receipt of the uplink scheduling grant information using the signal protection component.

5. The device of claim 4 wherein the uplink scheduling grant information comprises at least uplink allocation information.

6. The device of claim 5 where the device uses multiple contiguous resource units of a radio spectrum for performing signal transmission operations in the wireless communications system and wherein the uplink allocation information further comprises the resource units assigned to the device.

7. The device of claim 5 where the device uses multiple resource units of a radio spectrum for performing signal transmission operations in the wireless communications system, where at least some of the resource units are non-contiguous and where the uplink allocation information further comprises the resource units assigned to the device, and wherein the antenna weight feedback information further comprises a plurality of antenna weight feedback information sets, each antenna weight feedback information set for use with a contiguous set of resource units.

8. The device of claim 4 wherein the uplink scheduling grant information comprises at least user equipment identification information.

9. A device comprising:
a receiver configured to receive a first signal transmitted by a remote device operating in a wireless communication system;
a transmitter configured to transmit a second signal to the remote device operating in the wireless communication system; and
a control unit configured to use the first signal to select antenna weight feedback information; to generate the second signal, the second signal comprising at least the antenna weight feedback information, the antenna weight feedback information for use by the remote device when performing signal transmission operations; to add a signal protection component to the second signal; and to cause the transmitter to transmit the second signal with the signal protection component.

10. The device of claim 9 wherein the signal protection component is an error detection code.

11. The device of claim 10 wherein the error detection code is a CRC code.

12. The device of claim 9 wherein the signal protection component is an error correction code.

13. The device of claim 12 wherein the error correction code is a channel code.

14. The device of claim 9 wherein the antenna weight feedback information is signaled as part of an allocation table entry.

15. The device of claim 14 wherein the allocation table entry is of fixed length.

16. The device of claim 14 wherein the allocation table entry is of variable length.

17. The device of claim 9 wherein the device is a Node-B of an E-UTRAN wireless communications system.

18. The device of claim 9 wherein the second signal further comprises uplink scheduling grant information.

19. The device of claim 18 wherein the uplink scheduling grant information comprises at least uplink allocation information.

20. The device of claim 19 where the remote device uses multiple contiguous resource units of a radio spectrum for performing signal transmission operations in the wireless communications system and wherein the uplink allocation information further comprises the resource units assigned to the remote device.

21. The device of claim 19 where the remote device uses multiple resource units of a radio spectrum for performing signal transmission operations in the wireless communications system, wherein at least some of the resource units are non-contiguous and where the uplink allocation information further comprises the resource units assigned to the device, and wherein the antenna weight feedback information further comprises a plurality of antenna weight feedback information sets, each antenna weight feedback information set for use with a contiguous set of resource units.

22. The device of claim 18 wherein the uplink scheduling grant information comprises at least user equipment identification information.

23. A computer program product comprising a computer readable memory medium tangibly embodying a computer program, the computer program configured to be executed by processing apparatus associated with a wireless device operative in a wireless communications system, wherein when executed by the processing apparatus, the computer program is configured to cause the wireless device to receive a signal, the signal comprising antenna weight feedback information and a signal protection component; to verify correct receipt of the antenna weight feedback information using the signal protection component; and to use the antenna weight feedback information to control beamforming operations when the wireless device is performing signal transmission operations.

24. The computer program product of claim 23 wherein the signal further comprises an allocation table specific to the wireless device, the antenna weight feedback information comprising an entry in the allocation table.

25. The computer program product of claim 24 wherein the entry in the allocation table comprising the antenna weight feedback information is of fixed length.

26. The computer program product of claim 24 wherein the entry in the allocation table comprising the antenna weight feedback information is of variable length.

27. The computer program product of claim 23 where the signal protection component is a CRC code and wherein the computer program is further configured to cause the wireless device to use the CRC code to verify correct receipt of the antenna weight feedback information.

28. The computer program product of claim 23 where the signal protection component is a channel code and wherein the computer program is further configured to cause the wireless device to use the channel code to verify correct receipt of the antenna weight feedback information.

29. The computer program product of claim 23 wherein the wireless device comprises a TxAA-capable user equipment.

30. A computer program product comprising a computer readable memory medium tangibly embodying a computer program, the computer program configured to be executed by processing apparatus associated with a wireless device operative in a wireless communications system, wherein when executed by the processing apparatus, the computer program is configured to cause the wireless device to receive a first signal transmitted by a remote device operating in the wireless communications system; to use the first signal to select antenna weight feedback information for use by the remote device when the remote device performs signal transmission operations; to generate a second signal, the second signal comprising the antenna weight feedback information and a signal protection component; and to transmit the second signal to the remote device.

31. The computer program product of claim 30 wherein the second signal further comprises an allocation table, the antenna weight feedback information comprising an entry in the allocation table.

32. The computer program product of claim 30 wherein the entry in the allocation table comprising the antenna weight feedback information is of fixed length.

33. The computer program product of claim 30 wherein the entry in the allocation table comprising the antenna weight feedback information is of variable length.

34. The computer program product of claim 30 wherein the signal protection component is an error detection code.

35. The computer program product of claim 34 wherein the error detection code is a CRC code.

36. The computer program product of claim 30 wherein the signal protection component is an error correction code.

37. The computer program product of claim 36 wherein the error correction code is a channel code.

38. The computer program product of claim 30 wherein the wireless device is a Node B and the wireless communication system is an E-UTRAN system.

39. A method comprising:
receiving a signal comprising antenna weight feedback information and a signal protection component from a remote first wireless device operating in a wireless communications system;
verifying correct receipt of the antenna weight feedback information using the signal protection component; and
using the antenna weight feedback information to control beamforming when a second wireless device is using an antenna array to perform signal transmission operations.

40. A device comprising:
receiver means for receiving a signal from a remote transmitter operating in a wireless communication system, the signal comprising at least antenna weight feedback information and a signal protection component;
transmitter means for performing signal transmission operations;
an antenna array coupled to the transmitter means; and
control means for verifying correct receipt of the signal using the signal protection component; for causing the transmitter means to perform signal transmission operations; and, when the signal is verified as correctly received, for using the antenna weight feedback information to control beamforming operations when performing signal transmission operations using the antenna array.
